(19) United States
(12) Patent Application Publication
(10) Pub. No.: US 2014/0324373 A1
(43) Pub. Date: Oct. 30, 2014

(54) QUALITY CONTROL SENSOR METHOD, SYSTEM AND DEVICE FOR USE WITH BIOLOGICAL/ENVIRONMENTAL RAPID DIAGNOSTIC TEST DEVICES

(71) Applicant: FIO CORPORATION, Toronto (CA)

(72) Inventors: Qing Xiang, Toronto (CA); Michael Chmura, Mississauga (CA); Ian Fine, Thornhill (CA); Graham Greenland, Toronto (CA); Roman Zastawny, Etobicoke (CA)

(73) Assignee: FIO Corporation, Toronto (CA)

(21) Appl. No.: 14/359,375

(22) PCT Filed: Nov. 20, 2012
(86) PCT No.: PCT/CA2012/001071

§ 371 Date: May 20, 2014

Related U.S. Application Data
(60) Provisional application No. 61/561,919, filed on Nov. 20, 2011.
(60) Provisional application No. 61/648,299, filed on May 17, 2012.

(51) Int. Cl. G01N 35/00

(52) U.S. Cl. CPC G01N 35/00623
USPC 702/81

(57) ABSTRACT

Quality control (QC) sensor methods, systems and devices are for use with biological/environmental rapid diagnostic test (RDT) devices and provide for automatic timers, reminders and RDT cassette images. Sensors are calibrated and optimized, and provide for quality control of the RDT devices. Image analysis identifies cassette and patient information, and evaluates the processing and conditions of the RDT devices, cassettes and RDTs. Results may be accessed and analyzed remotely from the RDT devices. RDT chain of custody and workflow, incubation and reading sequences are tracked. A QC score for each unique patient RDT is determined based on QC criteria.

### FIELD OF THE INVENTION

The present invention relates generally to a quality control method, system and device, and more particularly to a quality control sensor method, system and device for use with biological/environmental rapid diagnostic test devices.

### BACKGROUND OF THE INVENTION

In the prior art, the use of rapid diagnostic tests (“RDTs”) may have been restricted and/or limited by inadequate, insufficient and/or lacking quality control (“QC”).

RDTs may be sensitive to and/or affected by temperature, pre-analytical steps, reading errors, and/or storage problems. There may be a number of existing problems associated with RDTs, including, for example, the following:
Temperature during shipping and/or storage may, from time to time, have been higher than an RDT's temperature specification, and/or a user of the RDT may not notice and/or pay sufficient heed to same, which may have led to one or more inaccurate diagnostic results.
RDTs may need to be read at a specific time and/or within a specific time period. One or more separate timers usually may have been shipped together with the RDTs. In the field, however, the timers may be lost, and/or the user(s) of the RDTs may work on other RDTs during an assay time. The assay time may not be accurately followed for one or more reasons, and/or it may be quite common to read an RDT too early and/or too late. Such factors may also have led to inaccurate diagnostic results.
In the field, doctors and/or nurses may have grouped patients together for RDTs when they have multiple patients. Perhaps to save time, doctors and/or nurses may have taken one or more patients' blood, added blood samples and/or buffers into RDTs, and/or counted time, in sequence. Previously, RDT users may have needed to be very careful not to mix various patients' RDTs and/or in timing each RDT correctly. However, it may have been very challenging to do so in the circumstances, perhaps due to multiple patients. And/or,
RDT reader devices may have been used in community healthcare centers, in villages, and/or in association with mobile healthcare facilities (e.g., such as, for example, in cars and/or tents). Providing for the continued working status and/or ongoing functionality of such devices may have been a big concern. Providing for the continued working status of real-time RDT monitoring devices, for example, may have presented huge quality control issues.

One or more of the above issues may have been related to RDT quality control and/or process control.

A QC sensor device, system and/or method may be required which monitors RDT expiration date and/or RDT storage (and/or shipping) temperature. A QC sensor device, system and/or method may be required which may automatically count RDT assay time. A QC sensor device, system and/or method may be required which may improve the throughput of RDT diagnoses.

As an aside, it is here noted that at least some portions of the present disclosure may apply equally well to non-RDT diagnostic tests, and the present invention and disclosures therefore will be appreciated by persons having ordinary skill in the art to extend to include and apply to such subject matter as well.

What may be needed is a QC sensor system, method and/or device which is remotely operable by a service provider who (operating portions thereof for end users) may preferably have expertise in diagnostics, image processing, cellular communications, user interfaces, software development, nano- and polymer chemistry, optics, information science, industrial design, and/or database solutions. The service provider's clinical expertise may preferably include internal medicine and/or infectious disease clinical practice and/or research, diagnostics, regulatory affairs, and/or clinical trials.

Some of Today's Related Challenges

The World Health Organization (“WHO”) may recommend that all cases of presumptive malaria be confirmed with a diagnostic test, yet most fevers may not receive proper diagnosis before treatment. Health workers in malaria endemic regions may often assume that fever may be caused by malaria and/or may over-treat with anti-malarial medication. Misdiagnosis may increase morbidity and/or mortality. Overtreatment may increase the risk of drug resistance. Valuable and/or limited health resources may thus be wasted.

While the adoption of malaria RDTs may have improved fever management, impact may have been hindered by factors such as quality issues, human error and/or variation of interpretation, some or all of which may decrease accuracy and/or impact quality of care. The same factors may impair the real-world accuracy of non-malaria RDTs as well.

Infectious disease surveillance in developing countries may be compromised by inaccurate, incomplete and/or stale data, perhaps due to the current labour-intensive and/or error-prone manual capture and/or transcription of diagnostic results. This may impair the ability of program managers to make timely, data-driven resource allocation decisions, perhaps leading to inefficient use of current resources.

Overview of Some Ancillary Devices, Systems and/or Methods

Preferably, the QC sensor system, method and/or device according to the present invention may be adapted for use with mobile digital diagnostics integrated with cloud information services, preferably empowering health workers to deliver more accurate diagnoses and/or health program managers to make evidence-based decisions.

Preferably, the QC sensor system, method and/or device according to the present invention may be adapted for use with a smartphone-based, mobile device used by health worker at point of care. Preferably, such an ancillary device may: (a) interpret commercially available infectious disease RDTs to improve diagnostic accuracy through digital image analysis; (b) automatically upload real-time, encrypted and/or geo-localized data (e.g., diagnostic, demographic, survey, and/or user workflow data) to a secure database in a cloud-based network; (c) automatically download guidance directives (e.g., clinical protocols, data capture surveys, and/or alerts) from health program managers to health workers, preferably incorporating medical best practices into users' workflow through digital aids; and/or (d) consolidate disparate mobile health programs on a single platform.

For example, such an ancillary device may be a universal reader for existing RDTs. It may enable quality imaging of RDTs at a time of interpretation. Such a device may preferably capture an image of the RDT at the time of interpretation, preferably under controlled composition and/or lighting. The image may preferably be transmitted to a cloud-based system for aggregation and/or later use. The device may also enable accurate RDT processing and/or interpretation at a point of care. It may preferably improve real-world accuracy of RDTs, preferably by facilitating workflow and/or objectively interpreting results. This automated interpretation may preferably be compatible with select malaria RDTs. Other disease targets may include HIV, Dengue, and Hepatitis (among others). The ancillary device may also enable digitization of patient information. Users may preferably enter patient information, responses to custom surveys, and/or results of any diagnostic test, preferably via touch screen. The ancillary devices may preferably combine this data with date, time, geo-location and/or other meta-information into a data set for transmission. The ancillary device may also enable automatic data aggregation. Data sets may preferably be transmitted to a cloud-based system, preferably in real-time over the local mobile phone network, for use by program managers. The ancillary devices may access medical best practices. Two-way communication with such devices may preferably allow program managers to disseminate current case management guidelines and/or data capture best practices, preferably for integration into everyday workflow. The ancillary devices may preferably host applications capable of making case management recommendations, preferably based on diagnostic results and/or patient symptoms.

Still by way of example, the system, method and/or computer readable medium according to the present invention may be adapted for use with one or more ancillary devices which may preferably possess/enable one or more of the following features: may facilitate simultaneous workflow of multiple RDTs; may have a simple user interface with visual cues for step-by-step training and/or operation; all content may be remotely managed through a cloud-based system by program managers; applications/updates to the device software, and/or custom surveys may be downloaded over a mobile phone network; all diagnostic functionality needed by health worker using RDTs may be performed on-board the devices, preferably without any need for cellular communication function; hundreds of patient records may be stored on-board the devices when beyond cell tower range and/or automatically transmitted when coverage may be restored; data records may be encrypted and/or securely transmitted using a secure hypertext transfer protocol (“https”); an automated routine QC check may be performed regularly (e.g., daily); may be run and/or be compatible with select applications on the Android operating system offered by Google Inc. of Mountain View, Calif. and/or on another mobile device operating system; may be battery powered, e.g., affording about four (4) days' operation per charge; hand crank and/or solar charging accessories may be available upon request; may afford GSM communication, e.g., EDGE, 2G and/or 3G; may include SIM card functionality; may enable geo-location via GPS; and/or may have a high-resolution and/or backlit LCD (e.g., a 3.75″ LCD), preferably with a capacitive touch screen.

Such ancillary devices may preferably possess/enable one or more of the following benefits: may put the skill of an expert RDT technician in the hands of minimally-trained health workers; may unify diagnosis and/or data; data from every clinical encounter may be captured for determining resource allocation and/or public health policy; may alert program managers of trend development and/or enable coordinated and/or timely responses; health workers may upgrade their skills through dissemination of best practices in case management; may be compatible in a broad range of point-of-care settings, e.g., clinics, health posts, community outreach, military theatres and/or airports; RDT images and/or aggregate clinical data may be easily used by program managers to quality control health workers and/or may help to identify those in need of remedial training; record keeping may facilitate accountability of resource distribution and/or utilization; and/or may serves as a platform for innovative applications, e.g., therapy guidance, drug authentication, and/or continuing medical education.

Preferably, the QC sensor system, method and/or device according to the present invention may also be adapted for use with a web interface accessible via any Internet-enabled computer by an authorized health program manager. Preferably, such an interface may: (a) enable storage, retrieval, and/or analysis of data; (b) enable remote and/or real-time monitoring/management of devices, users' workflows, quality control procedures, and/or data capture; (c) enable real-time dissemination of clinical protocols, surveys, and/or alerts to devices; (d) generate reports; (e) export/import data to/from other databases; and/or (f) enable real-time and/or two-way communication between program managers and/or health workers.

For example, such an ancillary interface may enable web-based access to a cloud-based system. It may enable data aggregation and/or storage. Preferably, data transmitted by devices in the field may be routed in real-time to a cloud-based data warehouse, preferably at least one which may employ enterprise-level data redundancy and/or off-site backup. Preferably, access may be password protected and/or no special IT infrastructure may be required. Such an ancillary interface may enable real-time reporting and/or analysis. Preferably, it may analyze data using customized reports (e.g., maps, statistical analyses, and/or graphs) updated regularly (e.g., every fifteen minutes) and/or search the data warehouse for up-to-the-second information. Such an interface may be enable dissemination of best practice guidelines. Preferably, it may be used to control workflow in clinics by transmitting custom surveys, device software updates, and/or medical best practice protocols. Such an interface may also remotely oversee devices and/or users. Preferably, it may send/receive messages and/or transmit alerts to devices in the field. Preferably, it may control quality of health worker performance and/or coordinate interventions, remotely. This interface may afford interoperability with other health information systems. Preferably, it may import and/or export data to and/or from external databases for enhanced access and/or data management. Preferably, it may leverage the latest reporting and/or analytical tools, and/or mobile health applications, e.g., drug authentication, GIS mapping, and/or SMS clinical follow up.

Still by way of example, the system, method and/or computer readable medium according to the present invention may be adapted for use with one or more ancillary interfaces which may preferably possess/enable one or more of the following features: may be web-hosted; may be accessed via an Internet browser (e.g., Internet Explorer, Safari, Firefox, and/or Chrome) on any computer; may not require any software and/or hardware installation; access may be protected through secure login; program managers may distribute accounts to authorized individuals; reports may be exported in multiple formats, e.g., .pdf, .csv, .xlsx, .docx, and/or .xml; advanced search function may enable customized query of database; may be based on more than forty (40+) search criteria; and/or data transmission and/or format may be compatible with future HL7 compliance and/or interoperability with existing databases and/or electronic medical record systems.

Such ancillary interfaces may preferably possess/enable one or more of the following benefits: may improve timely access by simultaneous authorized users from any Internet-enabled computer to accurate, real-time, and/or epidemiologic data from point-of-care to support program monitoring and/or evaluation, clinical practice quality control, surveillance, and/or data-driven resource allocation decisions; may help to build and manage human capital; may help to identify and/or foster highly productive health workers; may help to provide those in need of remedial training with appropriate materials and/or attention; may help to create and/or improve accountability and/or transparency by gaining and/or affording access to timely and/or auditable records of work performed; and/or may centralize disparate health system strengthening initiatives on one platform.

One or more of the aforementioned features and/or benefits of the ancillary devices and/or interfaces may potentially be achieved and/or improved in tandem with the QC sensor system, method and/or device according to the present invention.

It may be an object according to an aspect of one embodiment of the invention to provide a quality control (QC) method, system and/or device.

It may be an object according to an aspect of one embodiment of the invention to provide a QC sensor method, system and/or device for use with biological/environmental diagnostic test devices.

It may be an object according to an aspect of one embodiment of the invention to provide a QC sensor method, system and/or device for use with biological/environmental RDT devices.

It may be an object according to an aspect of one embodiment of the invention to provide a QC sensor method, system and/or device which provides for automatic timers, reminders and/or RDT cassette images.

It may be an object according to an aspect of one embodiment of the invention to provide a QC sensor method, system and/or device which provides sensors calibrated and/or optimized, and/or for quality control of RDT devices.

It may be an object according to an aspect of one embodiment of the invention to provide a QC sensor method, system and/or device which provides image analysis to identify cassette and/or patient information, and/or evaluates the processing and/or conditions of RDT devices, cassettes and/or RDTs.

It may be an object according to an aspect of one embodiment of the invention to provide a QC sensor method, system and/or device which provides for QC results to be accessed and/or analyzed remotely from the RDT devices.

It may be an object according to an aspect of one embodiment of the invention to provide a QC sensor method, system and/or device which tracks RDT chain of custody and/or RDT workflow, incubation and/or reading sequences.

It may be an object according to an aspect of one embodiment of the invention to provide a QC sensor method, system and/or device which provides for a QC score for each unique patient RDT to be determined based on QC criteria.

It may be an object of the invention to obviate and/or mitigate one or more of the above mentioned disadvantages and/or problems associated with the prior art, and/or to achieve one or more of the aforementioned objects of the invention.

### SUMMARY OF THE INVENTION

According to the invention, there is disclosed a quality control (QC) sensor method, system and/or device for use with one or more biological or environmental rapid diagnostic test (RDT) devices. Each of RDT devices has a RDT cassette bed. According to the QC sensor method, system and/or device, one or more QC sensors are provided for QC of the RDT devices. One or more RDT cassettes are provided with one or more barcodes and/or radio frequency identification (RFID) chips which encode cassette information associated with the cassettes. The QC sensors include a temperature sensor and/or the cassettes are provided with one or more color temperature pads. Cassette images taken of the cassettes include at least one of the color temperature pads. Analysis of a color change in the color temperature pads monitors, assesses and/or determines one or more storage temperatures associated with the cassettes. The QC sensor method, system and/or device provides for a wireless and/or hard-wired connection to a remote, central and/or distributed database. The QC sensors include a light sensor and/or a weight sensor associated with the cassette bed. A timer is provided as part of the RDT devices. The light sensor and/or the weight sensor determine when one of the cassettes is placed at a predetermined position. Then, the timer automatically commences an assay time count. When the assay time count is completed, (1) a RDT result is automatically read from the cassettes, and/or (2) an alert is presented by the RDT device as a reminder to take a cassette image of, or to read a RDT result from, the cassettes. A motor is provided in association with the cassette bed. When the RDT is completed, the motor moves the cassette bed into position for a camera of the RDT device to take a cassette image. When the cassette bed is moved into the aforesaid position, the camera automatically takes the cassette image. Camera parameters are recorded in association with each cassette image to determine working conditions associated with the camera. The camera parameters are transmitted to the database for access or analysis remotely from the devices. The cassettes are provided with one or more visual indicia of a predetermined intensity. Intensity software is provided to regularly require an intensity analysis or cassette image of the visual indicia, and/or each RDT result is accompanied by the intensity analysis or cassette image of the visual indicia when transmitted to the database. The cassettes are provided with one or more colored indicia which, when the RDT is valid or proceeds validly, are of a predetermined color. Color determining software is provided to regularly require a color analysis or cassette image of the colored indicia, and/or each RDT result is accompanied by the color analysis or cassette image of the colored indicia when transmitted to the database. Recognition software is provided which, together with the camera, enables detection and identification of the cassette and/or of labeling on the cassette. The QC sensor method, system and/or device tracks (a) times and/or durations of one or more workflow, incubation and/or reading sequences associated with the RDT, and/or (b) a workflow chain of custody associated with the RDT. The QC sensors include one or more optical or electric detection sensors. The QC sensor method, system and/or device provides for: (i) variation, calibration or optimization of one or more sensor parameters associated with the optical or electric detection sensors; (ii) an optical calibration method wherein fluorescence detection is performed, with multiple images being taken and/or assessed over time; (iii) optimization of the detection time based on multiple images being taken and/or assessed during one or more of the workflow and/or incubation sequences; (iv) qualitative and/or quantitative assay calibration and an associated method of labeling and/or cassette recognition; (v) a static calibration pattern to be accessible, one for each different RDT and/or type of RDT; (vi) pre-analysis of the RDT and/or cassette to be performed for detection of errors through images and/or pattern recognition; and/or (vii) calibration or adjustment of the optical detection sensors based on the assay type. A QC score for each unique patient RDT is determined, calculated and/or recorded, based on and/or with reference to one or more QC criteria.

According to the invention, there is also disclosed a quality control (QC) sensor method, system and/or device for use with one or more biological or environmental rapid diagnostic test (RDT) devices. Each of the RDT devices has a RDT cassette bed. According to the QC sensor method, system and/or device, one or more QC sensors are provided for QC of the RDT devices.

According to an aspect of one preferred embodiment of the invention, one or more RDT cassettes may preferably, but need not necessarily, be provided with one or more barcodes and/or radio frequency identification (RFID) chips which may preferably, but need not necessarily, encode cassette information associated with the cassettes.

According to an aspect of one preferred embodiment of the invention, the cassette information may preferably, but need not necessarily, include a lot number and/or an expiration date associated with the cassettes.

According to an aspect of one preferred embodiment of the invention, a barcode scanner may preferably, but need not necessarily, be provided and/or adapted to read said encoded cassette information of the barcodes.

According to an aspect of one preferred embodiment of the invention, a camera may preferably, but need not necessarily, be provided and/or adapted to take cassette images. Each of the cassette images may preferably, but need not necessarily, be of a respective one of the cassettes.

According to an aspect of one preferred embodiment of the invention, decoding software may preferably, but need not necessarily, be provided to decode the cassette information from the barcodes and/or the RFID chips.

According to an aspect of one preferred embodiment of the invention, one or more cassettes may preferably, but need not necessarily, be provided with one or more color temperature pads. Cassette images taken of the cassettes may preferably, but need not necessarily, include at least one of the color temperature pads. Analysis of a color change in the color temperature pads may preferably, but need not necessarily, monitor, assess and/or determine one or more storage temperatures associated with the cassettes.

According to an aspect of one preferred embodiment of the invention, the QC sensor method, system and/or device may preferably, but need not necessarily, provide for a wireless and/or hard-wired connection to a remote, central and/or distributed database.

According to an aspect of one preferred embodiment of the invention, the QC sensors may preferably, but need not necessarily, include a temperature sensor.

According to an aspect of one preferred embodiment of the invention, the QC sensors may preferably, but need not necessarily, include a light sensor associated with the cassette bed and/or the cassettes.

According to an aspect of one preferred embodiment of the invention, preferably when the light sensor may determine one of the cassettes to have been placed at a predetermined position and/or over the light sensor, and/or preferably when one of the cassettes may affect illumination reaching the light sensor, a timer may preferably but need not necessarily automatically commence an assay time count. Preferably, but not necessarily, when the assay time count may be completed, (i) a RDT result may preferably, but need not necessarily, be automatically read from the cassettes, and/or (ii) an alert may preferably, but need not necessarily, be presented by the RDT device, preferably as a reminder to take a cassette image of, and/or to read, a RDT result from the cassettes.

According to an aspect of one preferred embodiment of the invention, the QC sensors may preferably, but need not necessarily, include a weight sensor associated with, and/or under, the cassette bed and/or the cassettes.

According to an aspect of one preferred embodiment of the invention, preferably when the weight sensor may determine one of the cassettes to be bearing on the weight sensor, a timer may preferably but need not necessarily automatically commence an assay time count. Preferably, but not necessarily, when the assay time count may be completed, (i) a RDT result may preferably, but need not necessarily, be automatically read from the cassettes, and/or (ii) an alert may preferably, but need not necessarily, be presented by the RDT device, preferably as a reminder to take a cassette image of, and/or to read, a RDT result from the cassettes.

According to an aspect of one preferred embodiment of the invention, a motor may preferably, but need not necessarily, be provided in association with the cassette bed. Preferably but not necessarily when the RDT is completed, the motor may move the cassette bed into position, preferably for a camera of the RDT device to take a cassette image. Preferably but not necessarily when the cassette bed may be moved into the aforesaid position, the camera may preferably, but need not necessarily, automatically take the cassette image.

According to an aspect of one preferred embodiment of the invention, the cassette bed may preferably, but need not necessarily, be a round plate. The motor may preferably, but need not necessarily, rotate the round plate into the aforesaid position.

According to an aspect of one preferred embodiment of the invention, camera parameters may preferably, but need not necessarily, be recorded in association with each cassette image, preferably to determine working conditions associated with the camera and/or one or more optical detection sensors.

According to an aspect of one preferred embodiment of the invention, the camera parameters may preferably, but need not necessarily, include an exposure time and/or an opto-electro gain associated with the camera and/or with the optical detection sensors.

According to an aspect of one preferred embodiment of the invention, the camera parameters may preferably, but need not necessarily, be transmitted to the database for access and/or analysis remotely from the devices.

According to an aspect of one preferred embodiment of the invention, the cassettes may preferably, but need not necessarily, be provided with one or more visual indicia of a predetermined intensity. Intensity software may preferably, but need not necessarily, be provided to regularly require an intensity analysis and/or cassette image of the visual indicia. Each RDT result may preferably, but need not necessarily, be accompanied by the intensity analysis and/or cassette image of the visual indicia when transmitted to the database.

According to an aspect of one preferred embodiment of the invention, the cassettes may preferably, but need not necessarily, be provided with one or more colored indicia which, preferably when the RDT is valid and/or proceeds validly, are of a predetermined color. Color determining software may preferably, but need not necessarily, be provided to regularly require a color analysis and/or cassette image of the colored indicia. Each RDT result may preferably, but need not necessarily, be accompanied by the color analysis and/or cassette image of the colored indicia when transmitted to the database.

According to an aspect of one preferred embodiment of the invention, the color analysis and/or cassette image of the colored indicia may preferably, but need not necessarily, be performed at the beginning, middle, and/or end of the RDT.

According to an aspect of one preferred embodiment of the invention, recognition software may preferably, but need not necessarily, be provided which, preferably together with the camera, may enable detection and/or identification of the cassette and/or of labeling on the cassette.

According to an aspect of one preferred embodiment of the invention, the camera and/or the recognition software may preferably, but need not necessarily, together provide for optical character and/or hand-writing recognition of patient identification indicia provided on the cassette.

According to an aspect of one preferred embodiment of the invention, the QC sensor method, system and/or device may preferably, but need not necessarily, track one or more times and/or durations of one or more workflow, incubation and/or reading sequences associated with the RDT.

According to an aspect of one preferred embodiment of the invention, the QC sensor method, system and/or device may preferably, but need not necessarily, track a workflow chain of custody associated with the RDT.

According to an aspect of one preferred embodiment of the invention, the QC sensors may preferably, but need not necessarily, include one or more optical or electric detection sensors. The QC sensor method, system and/or device may preferably, but need not necessarily, provide for variation, calibration and/or optimization of one or more sensor parameters associated with the optical or electric detection sensors.

According to an aspect of one preferred embodiment of the invention, the QC sensors may preferably, but need not necessarily, include one or more optical detection sensors. The QC sensor method, system and/or device may preferably, but need not necessarily, provide for an optical calibration method wherein fluorescence detection may preferably be performed, preferably but not necessarily with multiple images being taken and/or assessed over time.

According to an aspect of one preferred embodiment of the invention, the QC sensors may preferably, but need not necessarily, include one or more optical detection sensors. The QC sensor method, system and/or device may preferably, but need not necessarily, provide for optimization of detection time, preferably based on multiple images which may preferably, but need not necessarily, be taken and/or assessed, preferably during one or more of the workflow and/or incubation sequences.

According to an aspect of one preferred embodiment of the invention, the QC sensor method, system and/or device may preferably, but need not necessarily, provide for qualitative and/or quantitative assay calibration and/or an associated method of labeling and/or cassette recognition.

According to an aspect of one preferred embodiment of the invention, the QC sensor method, system and/or device may preferably, but need not necessarily, provide for a static calibration pattern to be accessible, preferably but not necessarily one for each different RDT and/or type of RDT.

According to an aspect of one preferred embodiment of the invention, the QC sensor method, system and/or device may preferably, but need not necessarily, provide for pre-analysis of the RDT and/or cassettes to be performed, preferably for detection of errors and preferably through images and/or pattern recognition.

According to an aspect of one preferred embodiment of the invention, the errors which may preferably, but need not necessarily, be detectable include: user errors; manufacturing defects; blood in the buffer well; blood volume issues; already used diagnostic tests; and/or improper alignment of control and/or test lines.

According to an aspect of one preferred embodiment of the invention, the QC sensors may preferably, but need not necessarily, include one or more optical detection sensors. The QC sensor method, system and/or device may preferably, but need not necessarily, provide for calibration and/or adjustment of the optical detection sensors, preferably based on the assay type.

According to an aspect of one preferred embodiment of the invention, a QC score for each unique patient diagnostic test may preferably, but need not necessarily, be determined, calculated and/or recorded, preferably based on and/or with reference to one or more QC criteria.

According to an aspect of one preferred embodiment of the invention, the QC score may preferably, but need not necessarily, be recorded in a database for review and/or comparison, and/or to determine whether the QC score is within acceptable QC score parameters.

Other advantages, features and characteristics of the present invention, as well as methods of operation and functions of the related elements of the system, method, and device and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWING(S)

The novel features which are believed to be characteristic of the system, method, and device according to the present invention, as to the structure, organization, use, and method of operation, together with further objectives and advantages thereof, will be better understood from the following drawing(s) in which presently preferred embodiments of the invention will now be illustrated by way of example. It is expressly understood, however, that the drawing(s) are for the purpose of illustration and description only, and are not intended as a definition of the limits of the invention. In the accompanying drawing(s):

FIG. 1 is a schematic drawing of printed lines of a predetermined intensity provided, according to the invention, on a QC cassette attached to a RDT device.

### DETAILED DESCRIPTION OF THE PREFERRED EMBODIMENTS

Preferred embodiments of the quality control (“QC”) sensor system, method, and device according to the invention are alternately herein referred to, collectively and/or individually, as the QC system, method and/or device (or simply as the system, method and/or device). References to one or more of the QC sensor system, method and/or device may, if and as appropriate, be understood by persons having ordinary skill in the art to apply, mutatis mutandis, to the others.

As aforesaid, the QC sensor system, method and device according to the invention are preferably for use with one or more biological and/or environmental rapid diagnostic test (“RDT”) devices. Each of the RDT devices has a RDT cassette bed. According to the invention, QC sensors are provided for QC of the RDT devices.

RDT cassettes are preferably provided with barcodes and/or radio frequency identification (“RFID”) chips which preferably encode cassette information associated with the cassettes. The cassette information preferably includes a lot number and an expiration date associated with the cassettes. A barcode scanner is preferably provided and adapted to read the encoded cassette information of the barcodes. A camera is preferably provided and adapted to take cassette images. Each of the cassette images is preferably of a respective one of the cassettes. Decoding software is preferably provided to decode the cassette information from the barcodes and/or the RFID chips.

Cassettes are preferably provided with color temperature pads. Cassette images taken of the cassettes preferably include at least one of the color temperature pads. Analysis of a color change in the color temperature pads preferably monitors, assesses and/or determines storage temperatures associated with the cassettes.

The QC sensor method, system and/or device preferably provides for a wireless and/or hard-wired connection to a remote, central and/or distributed database.

The QC sensors preferably include a temperature sensor, a light sensor associated with the cassette bed (and the cassettes), and a weight sensor under or associated with the cassette bed (and the cassettes).

When the light sensor determines a cassette to have been placed at a predetermined position (or over the light sensor)—and in some embodiments, simply, if the cassette is determined to have affected any illumination reaching the light sensor—a provided timer preferably automatically commences an assay time count.

In some embodiments, when the weight sensor determines a cassette to be bearing on the weight sensor, the timer preferably automatically commences the assay time count.

Preferably, when the assay time count is completed, a RDT result is automatically read from the cassettes. In some embodiments, an alert might additionally or instead be presented by the RDT device as a reminder for the user to take a cassette image of, or to read, the RDT result from the cassette.

In some embodiments, a motor is preferably provided in association with the cassette bed. When the RDT is completed, the motor moves the cassette bed into position for a camera of the RDT device to take a cassette image. Preferably, when the cassette bed is moved into position, the camera automatically takes the cassette image. The cassette bed may, for example, be a round plate and the motor may rotate it (e.g., at a substantially constant speed) into position.

Camera parameters are preferably recorded in association with each cassette image to determine the working conditions associated with the camera (or optical detection sensors). References herein to a camera may be considered, if and as appropriate, to also extend more generally to optical detection sensors (alternately, “optical sensors”), and vice versa. The camera parameters preferably include an exposure time and/or an opto-electro gain associated with the camera. The camera parameters are transmitted to the database for access and analysis remotely from the devices.

The cassettes are provided with visual indicia of a predetermined intensity. Intensity software is provided to regularly require a cassette image and an intensity analysis of the visual indicia. Additionally or instead, the cassettes are provided with colored indicia which are of a predetermined color when the RDT is valid and proceeds validly. Color determining software is provided to regularly require a cassette image and color analysis of the colored indicia. (The cassette image and color analysis of the colored indicia is preferably performed at the beginning, middle, and/or end of the RDT.) Each RDT result is accompanied by the cassette image, and by the intensity and/or color analyses, when transmitted to the database.

Recognition software is provided which, together with the camera, enables detection and identification of the cassette and labeling thereon. The camera and the recognition software together provide for optical character and hand-writing recognition of patient identification indicia provided on the cassette.

The QC sensor method, system and device track the times and durations of the workflow, incubation and reading sequences—as well as the workflow chain of custody—associated with the RDT.

The QC sensors preferably include optical and electric detection sensors. Preferably, the QC sensor method, system and device provide for:
(a) variation, calibration and optimization of sensor parameters associated with the optical and electric detection sensors;
(b) an optical calibration method wherein fluorescence detection is performed, with multiple images being taken and assessed over time;
(c) optimization of the detection time based on multiple images being taken and assessed during the workflow and incubation sequences;
(d) qualitative and quantitative assay calibration and an associated method of labeling and cassette recognition;
(e) a static calibration pattern to be accessible, one for each different RDT and type of RDT;
(f) pre-analysis of the RDT and cassette to be performed for detection of errors through images and pattern recognition; and
(g) calibration and adjustment of the optical detection sensors based on the assay type.

According to subparagraph (f) of the preceding paragraph, the errors which may be detected include (among others): user errors; manufacturing defects; blood in the buffer well; blood volume issues; already used diagnostic tests; and improper alignment of control and test lines.

A QC score for each unique patient diagnostic test is preferably determined, calculated and recorded, based on and with reference to QC criteria. The QC score is recorded in the database for review and comparison, and to determine whether the QC score is within acceptable QC score parameters.

QC Sensor Method

Persons skilled in the art will appreciate that although some of the components, relations, functionalities and applications of the QC sensor system and device are not specifically referenced or described in conjunction with the QC sensor method, they may be used or adapted for use in association therewith. The QC sensor method is suitable for use with the QC sensor system and device described herein, but it is not so limited.

Computer Readable Medium

According to the invention, a computer readable medium (e.g., CD-ROM, DVD-ROM, flash USB stick, RAM, ROM, and/or other computer memory device) may also be provided which includes executable instructions physically stored thereon. According to the invention, the executable instructions are such that, upon execution, they preferably encode processors to perform the QC sensor method (according to the invention).

### Further Description

Preferably, according to the invention:
(a) RDT cassettes are taped with a barcode and/or RFID chip which contains information concerning the manufacture of the cassette, such as, for example, lot number and/or expiration date.
(b) According to the device, system and/or method of the present invention, a barcode scanner is provided. Preferably, the barcode scanner is adapted to read barcode information.
   In another embodiment according to the device, system and/or method of the present invention, a camera is provided. Preferably, the camera is able to take an image of the entire RDT cassette.
(c) According to the device, system and/or method of the present invention, software is preferably provided to decode barcode information.
(d) Each of the RDT cassettes is taped with a color temperature pad when manufactured. According to the device, system and/or method of the present invention, an image taken of the entire cassette preferably includes the color temperature pad, and/or analysis of the pad's color change is performed, preferably to monitor and/or assess the cassette storage temperature.
(e) According to the present invention, the device is wirelessly connected and/or hard-wired to a remote, central and/or distributed database.
(f) The device is provided with a temperature sensor.
(g) The device is provided with a light sensor under the cassette. Preferably, after the RDT cassette is placed on an assigned location (e.g., after sample blood and/or a buffer may be added), the light sensor signals the device, the device automatically counts the assay time, and/or the device automatically reads the RDT diagnostic result when the time is out.

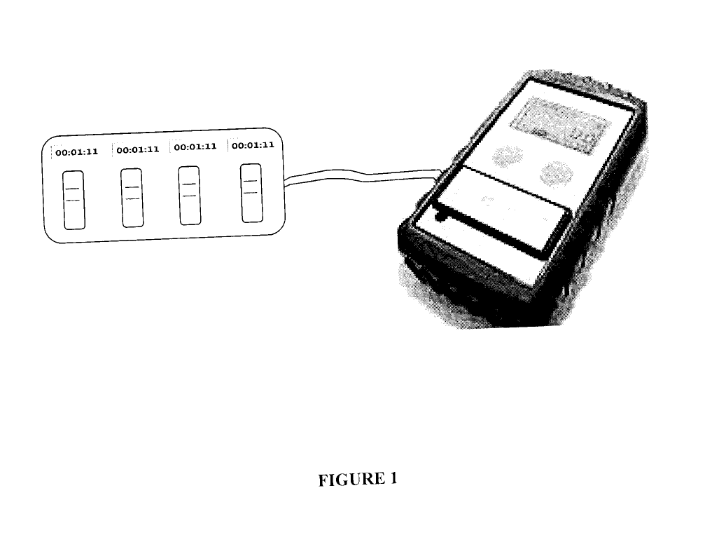

According to one embodiment of the invention, the device is optionally provided with a weight sensor under the cassette. Preferably, after the RDT is placed on an assigned location, the weight sensor signals the device (e.g., after the sample blood and/or buffer may be added), and/or the device automatically counts the assay time and/or reads the diagnostic result when the time is out.
(h) According to the present invention, the device is provided with a reader and/or a cassette bed. Preferably, the cassette bed is hard-wired and/or built into the reader. The cassette bed preferably contains several RDT-shaped indents. Each indent position preferably has a light sensor (and/or a weight sensor) and/or a timer. Preferably, after a RDT is placed on a bed and/or when the sample and/or buffer is added, the timer automatically starts. Preferably, after a remaining assay time reaches zero, a speaker (provided according to the present invention) beeps to remind one or more users of the device to take a RDT image.
   In addition and/or instead, the device is equipped with a motor according to the present invention. According to this embodiment of the invention, the RDT bed preferably is a round plate. Preferably, the motor rotates the round RDT bed at a specific speed. Preferably, after the assay time is out, the cassette is in a proper position for the camera to take a RDT image.
(i) According to the invention, the device is provided with an ability to record camera parameters when taking a RDT picture. These parameters preferably include, for example, (but are not limited to) exposure time and/or opto-electro gain of one or more associated optical sensors. Preferably, according to the invention, the device sends these parameters to the remote/central database. Preferably, if the device is not functional or working properly, these parameters may change. A database manager is preferably able to remotely determine the working condition of each of the devices. For point-of-care devices, it may be crucial to enable real-time monitoring of such devices' working conditions.
(j) The device is attached to a QC cassette. Several printed lines are provided on the QC cassette. See FIG. 1 for example. These printed lines preferably have a constant and/or specific intensity value. Preferably, the device software regularly requests users to test QC cassette intensity, and/or the QC cassette data is attached to every test result and/or sent to the database.
(k) According to one aspect of the present invention, pre-printed lines are provided on the cassette in a first color which, as a QC mechanism, change to a pre-determined second color if the test is valid and/or proceeds validly. Preferably, the sensor, device, system and/or method according to the invention provides for the color of the lines to be read at the beginning, middle and end of the test to see if it is valid.
(l) The sensor, device, system and/or method according to one aspect of the invention provides for detection of labeling on the cassette, as well as cassette detection and identification. Preferably, the sensor, device, system and/or method according to one aspect of the invention provides for hand-writing detection including, for example, patient name and/or patient ID, etc.
(m) According to one aspect of the invention, the sensor, device, system and/or method provides for time tracking of various workflow sequences (e.g., incubation sequences, reading sequences) associated with the RDT.
(n) The sensor, device, system and/or method according to one aspect of the invention provides and/or records the workflow chain of custody associated with the patient RDT.
(o) According to one aspect of the invention, the sensor, device, system and/or method provides for and/or enables variation, calibration and/or optimization of one or more of the optical and/or electric detection sensor parameters.
   The sensor, device, system and/or method according to one aspect of the invention provides for an associated optical calibration method. For example, according to one aspect of the invention, the optical calibration method preferably provides for fluorescence detection to be performed over time and/or at various different times (e.g., with multiple pictures/video being taken and/or assessed based on time).
   According to one aspect of the invention, the sensor, device, system and/or method provides for optimization of the detection time. For example, according to one aspect of the invention, the detection time is preferably optimized based on multiple pictures and/or video being taken and/or assessed during one or more of the workflow sequences (e.g., according to one aspect of the invention, preferably including during the incubation sequence).
(p) The sensor, device, system and/or method according to one aspect of the invention provides for qualitative assay calibration and/or quantitative assay calibration. For example, according to one aspect of the invention, the qualitative assay calibration and/or the quantitative assay calibration preferably involves and/or is associated with a method based on labeling and/or cassette recognition.
(q) According to one aspect of the invention, the sensor, device, system and/or method provides a static calibration pattern. For example, according to one aspect of the invention, a static calibration pattern is preferably provided and/or made available, one for each different test and/or type of test.
(r) The sensor, device, system and/or method according to one aspect of the invention provides for pre-analytical steps to be performed for error detection through images and/or pattern recognition. For example, according to one aspect of the invention, the errors so detectable preferably include user errors, manufacturing defects, blood in the buffer well, blood volume issues, already used RDTs, and/or improper alignment of control and test line (etc).
(s) According to one aspect of the invention, the sensor, device, system and/or method provides for calibration and/or adjustment of the optical sensor based on the assay type. And/or,
(t) The sensor, device, system and/or method according to one aspect of the invention provides, determines, calculates and/or records a QC score per unique patient RDT. The QC score is preferably determined and/or calculated, according to one aspect of the invention, in dependent relation based upon one or more of the other elements and/or features of the present invention which are described herein, and/or with reference to other QC criteria. According to one aspect of the invention, the QC score is preferably recorded in a database for review, comparison against other QC scores, and/or to ascertain whether and/or the extent to which the QC score might be within or outside of acceptable parameters.

Preferably, all of the aforementioned, depicted and various structures, configurations, relationships, processes, utilities and the like may be, but are not necessarily, incorporated into and/or achieved by one or more aspects of the invention. Any one or more of the aforementioned structures, configurations, relationships, processes, utilities and the like may be implemented in and/or by one or more aspects of the invention, on their own, and/or without reference, regard or likewise implementation of any of the other aforementioned structures, configurations, relationships, processes, utilities and the like, in various permutations and combinations, as will be readily apparent to those skilled in the art, without departing from the pith, marrow, and spirit of the disclosed invention.

This concludes the description of presently preferred embodiments of the invention. The foregoing description has been presented for the purpose of illustration and is not intended to be exhaustive or to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by any claims forming a part of this application, and/or the claims of any application claiming priority from this application, and/or any patent issuing thereon.

1-36. (canceled)

37. A quality control (QC) method for use with one or more biological or environmental rapid diagnostic test (RDT) devices, each having a RDT cassette bed; wherein according to the method one or more QC sensors are provided for QC of the RDT devices; and:
(a) wherein one or more RDT cassettes are provided with one or more barcodes and radio frequency identification (RFID) chips which encode cassette information associated with the cassettes;
(b) wherein the QC sensors include a temperature sensor and the cassettes are provided with one or more color temperature pads, wherein cassette images taken of the cassettes include at least one of the color temperature pads, and wherein analysis of a color change in the color temperature pads monitors, assesses and determines one or more storage temperatures associated with the cassettes;
(c) wherein the method comprises a step of providing a wireless and hard-wired connection to a remote, central and distributed database;
(d) wherein the QC sensors include a light sensor and a weight sensor associated with the cassette bed; wherein a timer is provided as part of the RDT devices; wherein the light sensor and the weight sensor determine when one of the cassettes is placed at a predetermined position, and then the timer automatically commences an assay time count; and wherein when the assay time count is completed, (i) a RDT result is automatically read from the cassettes, and (ii) an alert is presented by the RDT device as a reminder to take a cassette image of, or to read a RDT result from, the cassettes;
(e) wherein a motor is provided in association with the cassette bed; wherein when the RDT is completed, the motor moves the cassette bed into position for a camera of the RDT device to take a cassette image; and wherein when the cassette bed is moved into said position, the camera automatically takes the cassette image;
(f) wherein camera parameters are recorded in association with each cassette image to determine working conditions associated with the camera; and wherein the camera parameters are transmitted to the database for access or analysis remotely from the devices;
(g) wherein the cassettes are provided with one or more visual indicia of a predetermined intensity; wherein intensity software is provided to regularly require an intensity analysis or cassette image of the visual indicia, and wherein each RDT result is accompanied by the intensity analysis or cassette image of the visual indicia when transmitted to the database;
(h) wherein the cassettes are provided with one or more colored indicia which, when the RDT is valid or proceeds validly, are of a predetermined color; wherein color determining software is provided to regularly require a color analysis or cassette image of the colored indicia, and wherein each RDT result is accompanied by the color analysis or cassette image of the colored indicia when transmitted to the database;
(i) wherein recognition software is provided which, together with the camera, enables detection and identification of the cassette and of labeling on the cassette;
(j) wherein the method comprises a step of tracking (i) times and durations of one or more workflow, incubation and reading sequences associated with the RDT, and (ii) a workflow chain of custody associated with the RDT;
(k) wherein the QC sensors include one or more optical or electric detection sensors; and
(l) wherein the method comprises a step of providing for: (i) variation, calibration or optimization of one or more sensor parameters associated with the optical or electric detection sensors; (ii) an optical calibration method wherein fluorescence detection is performed, with multiple images being taken and assessed over time; (iii) optimization of the detection time based on multiple images being taken and assessed during one or more of the workflow and incubation sequences; (iv) qualitative and quantitative assay calibration and cassette recognition; (v) a static calibration pattern to be accessible, one for each different RDT and type of RDT; and (vi) calibration or adjustment of the optical detection sensors based on the assay type.

38. A quality control (QC) method for use with one or more biological or environmental rapid diagnostic test (RDT) devices, each having a RDT cassette bed; wherein the method comprises a step of providing the RDT devices with one or more QC sensors, with the QC sensors being usable in QC of the RDT devices.

39. A method according to claim 38, wherein one or more RDT cassettes are provided with one or more barcodes which encode cassette information associated with the cassettes.

40. A method according to claim 38, wherein one or more RDT cassettes are provided with one or more radio frequency identification (RFID) chips which encode cassette information associated with the cassettes.

41. A method according to claim 39, wherein said cassette information comprises a lot number and an expiration date associated with the cassettes.

42. A method according to claim 39, wherein a barcode scanner is provided and adapted to read said encoded cassette information of the barcodes.

43. A method according to claim 39, wherein a camera is provided and adapted to take cassette images, each of a respective one of the cassettes.

44. A method according to claim 39, wherein decoding software is provided to decode the cassette information from the barcodes.

45. A method according to claim 38, wherein one or more cassettes are provided with one or more color temperature pads, wherein cassette images taken of the cassettes include at least one of the color temperature pads, and wherein analysis of a color change in the color temperature pads monitors, assesses and determines one or more storage temperatures associated with the cassettes.

46. A method according to claim 38, which provides for a connection to a remote database.

47. A method according to claim 38, wherein the QC sensors comprise a temperature sensor.

48. A method according to claim 38, wherein the QC sensors comprise a light sensor associated with the cassette bed and the cassettes.

49. A method according to claim 48, wherein when the light sensor determines one of the cassettes is placed at a predetermined position or over the light sensor, or when one of the cassettes affects illumination reaching the light sensor, a timer automatically commences an assay time count, and when the assay time count is completed, (i) a RDT result is automatically read from the cassettes, or (ii) an alert is presented by the RDT device as a reminder to take a cassette image of, or to read, a RDT result from the cassettes.

50. A method according to claim 38, wherein the QC sensors comprise a weight sensor associated with the cassette bed and the cassettes.

51. A method according to claim 50, wherein when the weight sensor determines one of the cassettes is bearing on the weight sensor, a timer automatically commences an assay time count, and when the assay time count is completed, (i) a RDT result is automatically read from the cassettes, or (ii) an alert is presented by the RDT device as a reminder to take a cassette image of, or to read, a RDT result from the cassettes.

52. A method according to claim 38, wherein a motor is provided in association with the cassette bed; wherein when the RDT is completed, the motor moves the cassette bed into position for a camera of the RDT device to take a cassette image; and wherein when the cassette bed is moved into said position, the camera automatically takes the cassette image.

53. A method according to claim 52, wherein the cassette bed is a round plate, and wherein the motor rotates the round plate into said position.

54. A method according to claim 38, wherein camera parameters are recorded in association with each cassette image to determine working conditions associated with the camera.

55. A method according to claim 54, wherein the camera parameters comprise an exposure time or an opto-electro gain associated with the camera or one or more associated optical sensors.

56. A method according to claim 38, wherein the camera parameters are transmitted to a remote database for access or analysis remotely from the devices.

57. A method according to claim 38, wherein the cassettes are provided with one or more visual indicia of a predetermined intensity; wherein intensity software is provided to regularly require an intensity analysis or cassette image of the visual indicia, and wherein each RDT result is accompanied by the intensity analysis or cassette image of the visual indicia when transmitted to a remote database.

58. A method according to claim 38, wherein the cassettes are provided with one or more colored indicia which, when the RDT is valid or proceeds validly, are of a predetermined color; wherein color determining software is provided to regularly require a color analysis or cassette image of the colored indicia, and wherein each RDT result is accompanied by the color analysis or cassette image of the colored indicia when transmitted to a remote distributed database.

59. A method according to claim 38, wherein recognition software is provided which, together with the camera, enables detection and identification of the cassette and of labeling on the cassette.

60. A method according to claim 59, the camera and the recognition software together provide for optical character and hand-writing recognition of patient identification indicia provided on the cassette.

61. A method according to claim 38, which tracks one or more times or durations of one or more workflow, incubation or reading sequences associated with the RDT.

62. A method according to claim 38, which tracks a workflow chain of custody associated with the RDT.

63. A method according to claim 38, wherein the QC sensors include one or more optical or electric detection sensors; and which provides for variation, calibration or optimization of one or more sensor parameters associated with the optical or electric detection sensors.

64. A method according to claim 38, wherein the QC sensors include one or more optical detection sensors; and which provides for an optical calibration method wherein fluorescence detection is performed, with multiple images being taken or assessed over time.

65. A method according to claim 38, wherein the QC sensors include one or more optical detection sensors; which provides for optimization of detection time based on multiple images being taken or assessed during one or more of the workflow or incubation sequences.

66. A method according to claim 38, which provides for qualitative or quantitative assay calibration and cassette recognition.

67. A method according to claim 38, which provides for a static calibration pattern to be accessible, one for each different RDT or type of RDT.

68. A method according to claim 38, which provides for pre-analysis of the RDT or cassettes to be performed for detection of errors through images and pattern recognition, wherein the errors which are detectable include: user errors; manufacturing defects; blood in the buffer well; blood volume issues;
already used diagnostic tests; and improper alignment of control and test lines.

69. A method according to claim 38, wherein the QC sensors include one or more optical detection sensors; which provides for calibration and adjustment of the optical detection sensors based on the assay type.

70. A quality control (QC) system for use with one or more biological or environmental rapid diagnostic test (RDT) devices, each having a RDT cassette bed; wherein the system comprises one or more QC sensors for QC of the RDT devices; and:
(a) wherein the system further comprises one or more RDT cassettes provided with one or more barcodes and radio frequency identification (RFID) chips which encode cassette information associated with the cassettes;
(b) wherein the QC sensors include a temperature sensor and the cassettes are provided with one or more color temperature pads, wherein cassette images taken of the cassettes include at least one of the color temperature pads, and wherein analysis of a color change in the color temperature pads monitors, assesses and determines one or more storage temperatures associated with the cassettes;
(c) wherein the system further comprises a wireless and hard-wired connection to a remote, central and distributed database;
(d) wherein the QC sensors include a light sensor and a weight sensor associated with the cassette bed; wherein the system further comprises a timer which is provided as part of the RDT devices; wherein the light sensor and the weight sensor determine when one of the cassettes is placed at a predetermined position, and then the timer automatically commences an assay time count; and wherein when the assay time count is completed, (i) a RDT result is automatically read from the cassettes, and (ii) an alert is presented by the RDT device as a reminder to take a cassette image of, or to read a RDT result from, the cassettes;
(e) wherein the system further comprises a motor which is provided in association with the cassette bed; wherein when the RDT is completed, the motor moves the cassette bed into position for a camera of the RDT device to take a cassette image; and wherein when the cassette bed is moved into said position, the camera automatically takes the cassette image;
(f) wherein camera parameters are recorded in association with each cassette image to determine working conditions associated with the camera; and wherein the camera parameters are transmitted to the database for access or analysis remotely from the devices;
(g) wherein the cassettes are provided with one or more visual indicia of a predetermined intensity; wherein the system further comprises intensity software which is provided to regularly require an intensity analysis or cassette image of the visual indicia, and wherein each RDT result is accompanied by the intensity analysis or cassette image of the visual indicia when transmitted to the database;
(h) wherein the cassettes are provided with one or more colored indicia which, when the RDT is valid or proceeds validly, are of a predetermined color; wherein color determining software is provided to regularly require a color analysis or cassette image of the colored indicia, and wherein each RDT result is accompanied by the color analysis or cassette image of the colored indicia when transmitted to the database;
(i) wherein the system further comprises recognition software which, together with the camera, enables detection and identification of the cassette and of labeling on the cassette;
(j) wherein the system tracks (i) times and durations of one or more workflow, incubation and reading sequences associated with the RDT, and (ii) a workflow chain of custody associated with the RDT;
(k) wherein the QC sensors include one or more optical or electric detection sensors; and
(l) wherein the system provides for: (i) variation, calibration or optimization of one or more sensor parameters associated with the optical or electric detection sensors; (ii) an optical calibration method wherein fluorescence detection is performed, with multiple images being taken and assessed over time; (iii) optimization of the detection time based on multiple images being taken and assessed during one or more of the workflow and incubation sequences; (iv) qualitative and quantitative assay calibration and cassette recognition; (v) a static calibration pattern to be accessible, one for each different RDT and type of RDT; and (vi) calibration or adjustment of the optical detection sensors based on the assay type.

71. A quality control (QC) system for use with one or more biological or environmental rapid diagnostic test (RDT) devices, each having a RDT cassette bed; wherein the system comprises one or more QC sensors which are provided in association with the RDT devices, with the QC sensors being usable in QC of the RDT devices.

72. A system according to claim 71, further comprising one or more RDT cassettes provided with one or more barcodes which encode cassette information associated with the cassettes.

73. A system according to claim 71, further comprising one or more RDT cassettes provided with one or more radio frequency identification (RFID) chips which encode cassette information associated with the cassettes.

74. A system according to claim 72, wherein said cassette information comprises a lot number and an expiration date associated with the cassettes.

75. A system according to claim 72, further comprising a barcode scanner adapted to read said encoded cassette information of the barcodes.

76. A system according to claim 72, further comprising a camera adapted to take cassette images, each of a respective one of the cassettes.

77. A system according to claim 72, further comprising decoding software to decode the cassette information from the barcodes.

78. A system according to claim 71, further comprising one or more RDT cassettes provided with one or more color temperature pads, and a camera adapted to take cassette images, each of a respective one of the cassettes including at least one of the color temperature pads, wherein analysis of a color change in the color temperature pads monitors, assesses and determines one or more storage temperatures associated with the cassettes.

79. A system according to claim 71, further comprising a connection to a remote distributed database.

80. A system according to claim 71, wherein the QC sensors comprise a temperature sensor.

81. A system according to claim 71, further comprising one or more RDT cassettes; and
wherein the QC sensors comprise a light sensor associated with the cassette bed and the cassettes.

82. A system according to claim 81, wherein when the light sensor determines one of the cassettes is placed at a predetermined position or over the light sensor, or when one of the cassettes affects illumination reaching the light sensor, the system provides for a timer to automatically commence an assay time count, and when the assay time count is completed, (i) a RDT result is automatically read from the cassettes, or (ii) an alert is presented by the RDT device as a reminder to take a cassette image of, or to read, a RDT result from the cassettes.

83. A system according to claim 71, further comprising one or more RDT cassettes, wherein the QC sensors comprise a weight sensor associated with the cassette bed and the cassettes.

84. A system according to claim 83, wherein when the weight sensor determines one of the cassettes is bearing on the weight sensor, the system provides for a timer to automatically commence an assay time count, and when the assay time count is completed, (i) a RDT result is automatically read from the cassettes, or (ii) an alert is presented by the RDT device as a reminder to take a cassette image of, or to read, a RDT result from the cassettes.

85. A system according to claim 71, further comprising a motor provided in association with the cassette bed; wherein when the RDT is completed, the motor moves the cassette bed into position for a camera of the RDT device to take a cassette image; and wherein when the cassette bed is moved into said position, the camera automatically takes the cassette image.

86. A system according to claim 85, wherein the cassette bed is a round plate, and wherein the motor rotates the round plate into said position.

87. A system according to claim 71, further comprising one or more RDT cassettes and a camera adapted to take cassette images, each of a respective one of the cassettes; wherein camera parameters are recorded in association with each cassette image to determine working conditions associated with the camera.

88. A system according to claim 87, wherein the camera parameters comprise an exposure time or an opto-electro gain associated with the camera or one or more associated optical sensors.

89. A system according to claim 87, wherein the camera parameters are transmitted to a remote distributed database for access or analysis remotely from the RDT devices.

90. A system according to claim 71, further comprising one or more RDT cassettes provided with one or more visual indicia of a predetermined intensity; and further comprising intensity software to regularly require an intensity analysis or cassette image of the visual indicia, and wherein each RDT result is accompanied by the intensity analysis or cassette image of the visual indicia when transmitted to a remote database.

91. A system according to claim 71, further comprising one or more RDT the cassettes provided with one or more colored indicia which, when the RDT is valid or proceeds validly, are of a predetermined color; and further comprising color determining software to regularly require a color analysis or cassette image of the colored indicia, and wherein each RDT result is accompanied by the color analysis or cassette image of the colored indicia when transmitted to a remote database.

92. A system according to claim 71, further comprising: one or more RDT cassettes; a camera adapted to take cassette images, each of a respective one of the cassettes; and recognition software which, together with the camera, enables detection and identification of the cassette and of labeling on the cassette.

93. A system according to claim 92, wherein the camera and the recognition software together provide for optical character and hand-writing recognition of patient identification indicia provided on the cassette.

94. A system according to claim 71, wherein the system tracks one or more times or durations of one or more workflow, incubation or reading sequences associated with the RDT.

95. A system according to claim 71, wherein the system tracks a workflow chain of custody associated with the RDT.

96. A system according to claim 71, wherein the QC sensors include one or more optical or electric detection sensors; and wherein the system provides for variation, calibration or optimization of one or more sensor parameters associated with the optical or electric detection sensors.

97. A system according to claim 71, wherein the QC sensors include one or more optical detection sensors; and wherein the system provides for an optical calibration method wherein fluorescence detection is performed, with multiple images being taken or assessed over time.

98. A system according to claim 71, wherein the QC sensors include one or more optical detection sensors; and wherein the system provides for optimization of detection time based on multiple images being taken or assessed during one or more of the workflow or incubation sequences.

99. A system according to claim 71, wherein the system provides for qualitative or quantitative assay calibration and cassette recognition.

100. A system according to claim 71, wherein the system provides for a static calibration pattern to be accessible, one for each different RDT or type of RDT.

101. A system according to claim 71, wherein the system provides for pre-analysis of the RDT or cassettes to be performed for detection of errors through images and pattern recognition, wherein the errors which are detectable include: user errors; manufacturing defects; blood in the buffer well; blood volume issues; already used diagnostic tests; and improper alignment of control and test lines.

102. A system according to claim 71, wherein the QC sensors include one or more optical detection sensors; and wherein the system provides for calibration and adjustment of the optical detection sensors based on the assay type.
